(19) United States
(12) Patent Application Publication
(10) Pub. No.: US 2004/0152620 A1
(43) Pub. Date: Aug. 5, 2004

(54) Cosmetic composition containing mineral particles and a polyethyleneimine

(75) Inventors: Beatrice Perron, Jouy En Josas (FR); Laurence Paul, Saint Leu La Foret (FR); Serge Restle, Saint-Prix (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/718,531

(22) Filed: Nov. 24, 2003

Related U.S. Application Data
(60) Provisional application No. 60/432,623, filed on Dec. 12, 2002.

(30) Foreign Application Priority Data
Dec. 2, 2002 (FR) 0215175

(51) Int. Cl. C11D 1/00

(52) U.S. Cl. 510/499

(57) ABSTRACT

The invention relates to a composition containing

solid mineral particles having at least one element from columns IIa, IIIa and IVa of the Periodic Table of the Elements, and

at least one polyalkyleneimine,

where the polyalkyleneimine/mineral particle weight ratio ranging from 0.1 to 0.0001. These compositions give the hair texture (greater sensation of thickness) and better hold of the hairstyle.

### REFERENCE TO PRIOR APPLICATIONS

This application claims priority to U.S. provisional application 60/432,623 filed Dec. 12, 2002, and to French patent application 0215175 filed Dec. 2, 2002, both incorporated herein by reference.

### FIELD OF THE INVENTION

The present invention relates to a composition, especially a hair composition, comprising, in a cosmetically acceptable medium, mineral particles and at least one polyalkyleneimine. The invention is also directed towards a cosmetic hair treatment process comprising the application of this composition and also its use, especially as a rinse-out hair product.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

It is common practice to use detergent hair compositions (or shampoos), based essentially on standard surfactants in particular of anionic, nonionic and/or amphoteric type, but more particularly of anionic type, to clean and/or wash the hair. These compositions are applied to wet hair and the lather generated by massaging or rubbing with the hands allows, after rinsing with water, the removal of the diverse soiling initially present on the hair.

Admittedly, these base compositions have a good washing power, but their intrinsic cosmetic properties nevertheless remain fairly poor, especially due to the fact that the relatively aggressive nature of such a cleaning treatment can in the long run result in more or less pronounced damage to the hair fiber, associated in particular with the gradual removal of the lipids or proteins contained in or on the surface of the said fiber.

Thus, to improve the cosmetic properties of the above compositions, and more particularly of those intended to be applied to sensitized hair (i.e. hair that is in a damaged or embrittled condition, especially due to the chemical action of atmospheric agents and/or hair treatments such as permanent-waving, dyeing or bleaching operations), it is now common practice to introduce into these compositions additional cosmetic agents known as conditioners, which are mainly intended to repair or limit the harmful or undesirable effects induced by the various treatments or attacking factors to which hair fibers are more or less repeatedly subjected. These conditioners can, of course, also improve the cosmetic behaviour of natural hair.

The conditioners most commonly used to date in shampoos are cationic polymers, silicones and/or silicone derivatives, which give washed, dry or wet hair markedly increased ease of disentangling and softness when compared with that which may be obtained with the corresponding conditioner-free cleansing compositions.

However, these cosmetic advantages are unfortunately also accompanied, on dried hair, by certain cosmetic effects considered undesirable, namely lankness of the hairstyle and a lack of smoothness.

In addition, the use of cationic polymers for this purpose has many drawbacks. On account of their strong affinity for the hair, some of these polymers become deposited in a substantial amount during repeated uses, and lead to undesirable effects such as an unpleasant, laden feel, stiffening of the hair, and adhesion between fibers which affects the styling. These drawbacks are accentuated in the case of fine hair, which lacks liveliness and volume.

It has already been proposed to use particles in rinse-out compositions, so as to improve the feel and appearance of the hair. By way of illustration, patent U.S. Pat. No. 5,334,376 proposes the addition of calcium carbonate particles to hair-conditioning compositions containing a silicone, a fatty alcohol and an amide.

In patent application DE 199 46 784, it has also been proposed to use particles of various oxides, hydroxides, carbonates, silicates or phosphates in hair compositions, to reduce the greasy appearance of the hair. It is generally envisaged to combine these particles with standard shampoo ingredients.

However, despite the progress recently made in the field of rinse-out hair products and especially shampoos, these products do not truly give total satisfaction, and as such there is currently still a strong need to provide novel products that show better performance qualities in one or more of their properties.

### DETAILED DESCRIPTION OF THE PREFERRED EMBODIMENTS

The inventors have discovered, surprisingly and unexpectedly, that by selecting the conditioner, combined with particular mineral particles, it is possible to improve the results obtained with products, especially cosmetic products like rinse-out hair products, in terms of cosmetic properties and hairsetting properties. In particular, the hair is given texture (greater sensation of thickness) and better hold of the hairstyle.

One subject of the invention is a composition, especially a hair composition, comprising, in a cosmetically acceptable medium:

(a) solid mineral particles comprising at least one element from columns IIa, IIIa and IVa of the Periodic Table of the Elements, and

(b) at least one polyalkyleneimine,

the polyalkyleneimine/mineral particle weight ratio being 0.1-0.0001.

For purposes of this invention, the version of the Periodic Table used is the CAS version (Chemical Associated Society). It is included for example in the book “The Merck Index” 11ed. 1989.

Another subject of the present invention is a cosmetic hair treatment process using the composition according to the invention.

A subject of the invention is also the use of the invention composition to give the hair texture (greater sensation of thickness) and better hold of the hairstyle.

A subject of the invention is also the use of the invention composition in hair cosmetics, especially in rinse-out hair application, especially as a shampoo.

Other subjects, characteristics, aspects and advantages of the invention will emerge evenly more clearly on reading the description and the various examples that follow.

(a) Mineral Particles

The solid mineral particles comprise at least one element from columns IIa, IIIa and IVa of the Periodic Table of the Elements and preferably from columns IIa and IVa. Mixtures may be used. They are especially chosen from particles containing at least 10% by weight of calcium carbonate or of at least one silicate, particles containing at least 90% aluminium oxide, silicas, magnesium oxide and barium sulphate, and mixtures thereof.

The solid mineral particles preferably have a number-average primary size of between 2 nm and 2 microns, more preferably between 5 nm and 500 nm and even more preferably between 10 nm and 250 nm.

The particles according to the invention may, for example, have any form, for example the form of spheres, flakes, needles, platelets or totally random forms. They are preferably substantially spherical.

For the purposes of the present invention, the expression “primary particle size” means the maximum size that it is possible to measure between two diametrically opposite points on an individual particle. The size may be determined, for example, by transmission electron microscopy or from measuring the specific surface via the BET method, or alternatively by means of a laser granulometer.

In accordance with the present invention, the particle may be a bulk particle formed entirely from calcium carbonate. Calcium carbonate may also totally or partially constitute the core of the particle, this core being covered with another constituent, for example an oxide, a silicate or a metal. Calcium carbonate may also exclusively form the coating of a substrate of different chemical constitution, for example an oxide, a silicate or a metal.

In the case where the particles are formed from calcium carbonate and other fillers, the calcium carbonate is in free form and does not form chemical bonds with the other fillers. This is then a case of an alloy between the calcium carbonate and other fillers, especially with metal oxides or metalloid oxides, obtained in particular by thermal fusion of these various constituents.

When the particles containing at least 10% by weight of calcium carbonate also comprise a metal oxide or a metalloid oxide, this oxide is chosen especially from silicon oxide, boron oxide and aluminium oxide, and mixtures thereof.

The particles preferably contain at least 50% by weight of calcium carbonate, better still at least 70% by weight, and particles consisting of more than 90% by weight of calcium carbonate are particularly preferred according to the present invention.

Even more advantageously, the particles containing at least 10% by weight of calcium carbonate are particles of substantially pure calcium carbonate.

The calcium carbonate that is suitable for use in the compositions of the present invention may be of natural origin or may be of synthetic origin. In the latter case, it may be obtained from calcium oxide, calcium peroxide, calcium acetate or calcium ethoxide.

The aluminium oxide particles according to the invention preferably consist essentially of any optionally hydrated alumina, for instance boehmite.

The silicates that may be used according to the invention include those chosen from sodium silicate, magnesium silicate and/or lithium silicate. The compounds sold by the company Laporte under the name Laponite XLG and Laponite XLS may especially be used.

When the particles containing at least 10% by weight of at least one silicate also comprise a metal oxide or a metalloid oxide, this oxide is preferably chosen from silicon oxide, boron oxide and aluminium oxide, and mixtures thereof.

The silicates that are suitable for use in the compositions of the present invention may be of natural origin or of synthetic origin.

The mineral particles according to the invention are preferably used in an amount of between 0.01% and 30% by weight, more preferably between 0.05% and 10% by weight and more particularly between 0.1% and 5% by weight relative to the total weight of the composition.

The composition according to the invention may also contain other types of particles, for example titanium oxide or zinc oxide particles.

(b) Polyalkyleneimine

The polyalkyleneimines preferably used according to the invention are polymers containing from 6 to 20 000 repeating units. Mixtures may be used. Polyalkyleneimines comprising at least 5% of tertiary amines, advantageously at least 10% and even more preferably at least 20% of tertiary amine functions, are preferably selected. These polymers may be linear or branched homopolymers or copolymers, or homopolymers or copolymers of dendrimer structure.

These polymers preferably comprise the following repeating units:

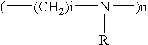

in which:

i represents an integer greater than or equal to 2 and preferably less than or equal to 6;

preferentially, i=2;

n represents an integer ranging from 6 to 20 000 and preferably from 8 to 2 500;

R represents a hydrogen atom or a unit

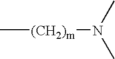

in which m represents an integer greater than or equal to 2; preferentially, m=2.

These polymers are generally terminated with amine end functions and especially primary amines.

According to the invention, the polyalkyleneimines are preferably poly(C2-C4)alkyleneimines and more particularly polyethyleneimines.

The polyalkyleneimines used in accordance with the invention preferably have a weight-average molecular weight ranging from 300 to 100 000, preferably from 350 to 50 000, more particularly from 400 to 10 000 and preferentially from 500 to 2 000.

Polyalkyleneimines having these molecular weights can improve the dispersion of the mineral particles and consequently their deposition.

The molecular weights may be determined by quasi-elastic light scattering.

The polyalkyleneimines preferably have a cationic charge density of less than or equal to 20 meq/g and preferably greater than or equal to 0.05 meq/g, and more particularly from 4 to 20 meq/g.

The charge density may be determined according to the Kjeldahl method or calculated.

The polyalkyleneimines are described especially in the book “Polymer Science Dictionary” 2nd edition, Mark Alger, Chapman & Hall, 1997.

The polyalkyleneimines are preferably present in the compositions according to the invention in proportions ranging from 0.0005% to 5% by weight, preferentially from 0.001% to 1% by weight, more particularly from 0.005% to 0.05% by weight and even more preferentially from 0.005% to 0.25% by weight relative to the total weight of the composition.

The polyalkyleneimine(s) may preferably be used in a weight ratio with the mineral particles ranging from 0.1 to 0.0001 and preferably from 0.05 to 0.001.

The compositions of the invention also preferably comprise at least one surfactant, which may be present in, for example, an amount of between 0.2% and 40% by weight approximately, preferably between 1% and 35% and even more preferentially between 1.5% and 30%, relative to the total weight of the composition.

The surfactants that are suitable for use in performing the present invention may be of any nature and are preferably soluble in water at room temperature:

(i) Anionic Surfactant(s):

In the context of the present invention, their nature is not a truly critical feature.

Thus, as examples of anionic surfactants which can be used, alone or as mixtures, in the context of the present invention, mention may be made in particular (non-limiting list) of salts (in particular alkaline salts, especially sodium salts, ammonium salts, amine salts, amino alcohol salts or magnesium salts) of the following compounds: alkyl sulphates, alkyl ether sulphates, alkylamido ether sulphates, alkylarylpolyether sulphates, monoglyceride sulphates; alkyl sulphonates, alkyl phosphates, alkylamide sulphonates, alkylaryl sulphonates, α-olefin sulphonates, paraffin sulphonates; alkyl sulphosuccinates, alkyl ether sulphosuccinates, alkylamide sulphosuccinates; alkyl sulphosuccinamates; alkyl sulphoacetates; alkyl ether phosphates; acyl sarcosinates; acyl isethionates and N-acyltaurates, the alkyl or acyl radical of all of these various compounds preferably containing from 8 to 24 carbon atoms, and the aryl radical preferably denoting a phenyl or benzyl group. Among the anionic surfactants which can also be used, mention may also be made of fatty acid salts such as the salts of oleic, ricinoleic, palmitic and stearic acids, coconut oil acid or hydrogenated coconut oil acid; acyl lactylates in which the acyl radical contains 8 to 20 carbon atoms. Weakly anionic surfactants can also be used, such as alkyl-D-galactosiduronic acids and their salts, as well as polyoxyalkylenated (C₆-C₂₄) alkyl ether carboxylic acids, polyoxyalkylenated (C₆-C₂₄) alkylaryl ether carboxylic acids, polyoxyalkylenated (C₆-C₂₄) alkylamido ether carboxylic acids and their salts, in particular those containing from 2 to 50 ethylene oxide groups, and mixtures thereof.

Among the anionic surfactants, it is preferred according to the invention to use alkyl sulphate salts and alkyl ether sulphate salts and mixtures thereof.

(ii) Nonionic Surfactant(s):

The nonionic surfactants are, themselves also, compounds that are well known per se (see in particular in this respect “Handbook of Surfactants” by M. R. Porter, published by Blackie & Son (Glasgow and London), 1991, pp. 116-178) and, in the context of the present invention, their nature is not a critical feature. Thus, they can be chosen in particular from (non-limiting list) polyethoxylated, polypropoxylated or polyglycerolated fatty acids, alkylphenols, α-diols or alcohols having a fatty chain containing, for example, 8 to 18 carbon atoms, it being possible for the number of ethylene oxide or propylene oxide groups to range in particular from 2 to 50 and for the number of glycerol groups to range in particular from 2 to 30. Mention may also be made of copolymers of ethylene oxide and of propylene oxide, condensates of ethylene oxide and of propylene oxide with fatty alcohols; polyethoxylated fatty amides preferably having from 2 to 30 mol of ethylene oxide, polyglycerolated fatty amides containing 1 to 5, and in particular 1.5 to 4, glycerol groups; oxyethylenated fatty acid esters of sorbitan having from 2 to 30 mol of ethylene oxide; fatty acid esters of sucrose, fatty acid esters of polyethylene glycol, alkylpolyglycosides, N-alkylglucamine derivatives, amine oxides such as (C₁₀-C₁₄)alkylamine oxides or N-acylaminopropylmorpholine oxides. It will be noted that the alkylpolyglycosides constitute nonionic surfactants that are particularly suitable in the context of the present invention.

(iii) Amphoteric or Zwitterionic Surfactant(s):

The amphoteric or zwitterionic surfactants, whose nature is not a critical feature in the context of the present invention, can be, in particular (non-limiting list), aliphatic secondary or tertiary amine derivatives in which the aliphatic radical is a linear or branched chain containing 8 to 18 carbon atoms and containing at least one water-soluble anionic group (for example carboxylate, sulphonate, sulphate, phosphate or phosphonate); mention may also be made of (C₈-C₂₀) alkylbetaines, sulphobetaines, (C₈-C₂₀)alkylamido (C₁-C₆)alkylbetaines or (C₈-C₂₀) alkylamido (C₁-C₆) alkylsulphobetaines.

Among the amine derivatives, mention may be made of the products sold under the name Miranol, as described in U.S. Pat. Nos. 2,528,378 and 2,781,354 and classified in the CTFA dictionary, 3^{rd} edition, 1982 under the names amphocarboxy glycinates and amphocarboxy propionates and having the respective structures:

R₂—CONHCH₂CH₂—N(R₃)(R₄)(CH₂COO—) (2)

in which: R₂ denotes an alkyl radical derived from an acid R₂—COOH present in hydrolysed coconut oil, a heptyl, nonyl or undecyl radical, R₃ denotes a β-hydroxyethyl group and R₄ denotes a carboxymethyl group;

and

R_{2′} —CONHCH₂CH₂—N(B)(C) (3)

in which:

B represents —CH₂CH₂OX′, C represents —(CH₂)_{z}—Y′, with z=1 or 2,

X′ denotes the —CH₂CH₂—COOH group or a hydrogen atom,

Y′ denotes —COOH or the —CH₂—CHOH—SO₃H radical,

R_{2′} denotes an alkyl radical of an acid R₉—COOH present in coconut oil or in hydrolysed linseed oil, an alkyl radical, in particular a C₇, C₉, C₁₁ or C₁₃ alkyl radical, a C₁₇ alkyl radical and its iso form, an unsaturated C₁₇ radical.

By way of example, mention may be made of the cocoamphodiacetate sold under the trade name Miranol C2M concentrated NP by the company Rhodia Chimie.

(iv) Cationic Surfactants:

The cationic surfactants may be chosen from:

A) the quaternary ammonium salts of general formula (XII) below:

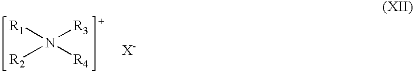

in which X⁻ is an anion chosen from the group of halides (chloride, bromide or iodide) or (C₂-C₆)alkyl sulphates, more particularly methyl sulphate, phosphates, alkyl or alkylaryl sulphonates, anions derived from organic acid, such as acetate or lactate, and

i) the radicals R1 to R3, which may be identical or different, represent a linear or branched aliphatic radical containing from 1 to 4 carbon atoms, or an aromatic radical such as aryl or alkylaryl. The aliphatic radicals can comprise hetero atoms such as, in particular, oxygen, nitrogen, sulphur or halogens. The aliphatic radicals are chosen, for example, from alkyl, alkoxy and alkylamide radicals, R4 denotes a linear or branched alkyl radical containing from 16 to 30 carbon atoms.

The cationic surfactant is preferably a cetyltrimethylammonium salt (for example chloride).

ii) the radicals R1 and R2, which may be identical or different, represent a linear or branched aliphatic radical containing from 1 to 4 carbon atoms, or an aromatic radical such as aryl or alkylaryl. The aliphatic radicals can comprise hetero atoms such as, in particular, oxygen, nitrogen, sulphur or halogens. The aliphatic radicals are chosen, for example, from alkyl, alkoxy, alkylamide and hydroxyalkyl radicals containing from about 1 to 4 carbon atoms;

R3 and R4, which may be identical or different, denote a linear or branched alkyl radical containing from 12 to 30 carbon atoms, the said radical comprising at least one ester or amide function.

R3 and R4 are chosen in particular from (C₁₂-C₂₂)alkylamido (C₂-C₆)alkyl and (C₁₂-C₂₂)alkylacetate radicals.

The cationic surfactant is preferably a stearamidopropyldimethyl (myristyl acetate) ammonium salt (for example chloride).

B)—the quaternary ammonium salts of imidazolinium, such as, for example, that of formula (XIII) below:

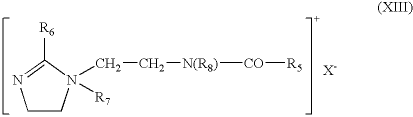

in which R₅ represents an alkenyl or alkyl radical containing from 8 to 30 carbon atoms, for example fatty acid derivatives of tallow, R6 represents a hydrogen atom, a C₁-C₄ alkyl radical or an alkenyl or alkyl radical containing from 8 to 30 carbon atoms, R₇ represents a C₁-C₄ alkyl radical, R₈ represents a hydrogen atom or a C₁-C₄ alkyl radical, and X is an anion chosen from the group of halides, phosphates, acetates, lactates, alkyl sulphates, alkyl sulphonates or alkylaryl sulphonates. R₅ and R₆ preferably denote a mixture of alkenyl or alkyl radicals containing from 12 to 21 carbon atoms, such as, for example, fatty acid derivatives of tallow, R₇ denotes methyl and R₈ denotes hydrogen. Such a product is, for example, Quaternium-27 (CTFA 1997) or Quaternium-83 (CTFA 1997), which are sold under the names “Rewoquat” W75, W90, W75PG and W75HPG by the company Witco,

C)—the diquaternary ammonium salts of formula (XIV):

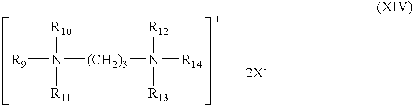

in which R₉ denotes an aliphatic radical containing from about 16 to 30 carbon atoms, R₁₀, R₁₁, R₁₂, R₁₃ and R₁₄, which may be identical or different, are chosen from hydrogen and an alkyl radical containing from 1 to 4 carbon atoms, and X is an anion chosen from the group of halides, acetates, phosphates, nitrates and methyl sulphates. Such diquaternary ammonium salts in particular comprise propanetallowdiammmonium dichloride.

D)—the quaternary ammonium salts containing at least one ester function, of formula (XV) below:

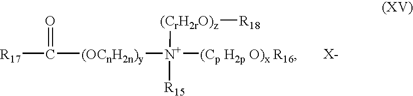

in which:

R₁₅ is chosen from C₁-C₆ alkyl radicals and C₁-C₆ hydroxyalkyl or dihydroxyalkyl radicals;

R₁₆ is chosen from:

a radical

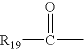

linear or branched, saturated or unsaturated C₁-C₂₂ hydrocarbon-based radicals R₂₀,

a hydrogen atom,

R₁₈ is chosen from:

a radical

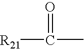

linear or branched, saturated or unsaturated C₁-C₆ hydrocarbon-based radicals R₂₂,

a hydrogen atom,

R₁₇, R₁₉ and R₂₁, which may be identical or different, are chosen from linear or branched, saturated or unsaturated C₇-C₂₁ hydrocarbon-based radicals;

n, p and r, which may be identical or different, are integers ranging from 2 to 6;

y is an integer ranging from 1 to 10;

x and z, which may be identical or different, are integers ranging from 0 to 10;

X⁻ is a simple or complex, organic or inorganic anion; with the proviso that the sum x+y+z is from 1 to 15, that when x is 0, then R₁₆ denotes R₂₀ and that when z is 0, then R₁₈ denotes R₂₂.

Use is made more particularly of the ammonium salts of formula (XV) in which:

R₁₅ denotes a methyl or ethyl radical,

x and y are equal to 1;

z is equal to 0 or 1;

n, p and r are equal to 2;

R₁₆ is chosen from:

a radical

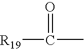

methyl, ethyl or C₁₄-C₂₂ hydrocarbon-based radicals,

a hydrogen atom;

R₁₇, R₁₉ and R₂₁, which may be identical or different, are chosen from linear or branched, saturated or unsaturated C₇-C₂₁ hydrocarbon-based radicals;

R₁₈ is chosen from:

a radical

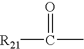

a hydrogen atom.

Such compounds are sold, for example, under the names Dehyquart by the company Cognis, Stepanquat by the company Stepan, Noxamium by the company Ceca, and Rewoquat WE 18 by the company Rewo-Witco.

Among the quaternary ammonium salts that are preferred are cetyltrimethylammonium chloride, behenyltrimethylammonium chloride or palmitamidopropyltrimethylammonium chloride sold under the name Varisoft PA TC by the company Goldschmidt.

The anionic surfactants preferably used are sodium, triethanolamine or ammonium (C₁₂-C₁₄) alkyl sulphates, sodium, triethanolamine or ammonium (C₁₂-C₁₄)alkyl ether sulphates oxyethylenated with 2.2 mol of ethylene oxide, sodium cocoyl isethionate and sodium α-(C₁₄-C₁₆)olefin sulphonate, and mixtures thereof, with:

either an amphoteric surfactant such as the amine derivatives known as disodium cocoamphodiacetate or sodium cocoamphopropionate sold especially by the company Rhodia Chimie under the trade name “Miranol® C2M CONCNP” as an aqueous solution containing 38% active material, or under the name Miranol® C32;

or an amphoteric surfactant such as alkylbetaines, in particular the cocobetaine sold under the name “Dehyton® AB 30” as an aqueous solution containing 32% AM by the company Cognis, or such as (C₈-C₂₀) alkylamido (C₁-C₆)alkylbetaines, in particular Tegobetaine® F 50 sold by the company Goldschmidt.

The cosmetically acceptable medium may consist solely of water or of a mixture of water and one or more cosmetically acceptable solvents or of one or more cosmetically acceptable solvents, such as a C₁-C₄ lower alcohol, for instance ethanol, isopropanol, tert-butanol or n-butanol; alkylene glycols, for instance propylene glycol, and glycol ethers. Water preferably represents from 30% to 98% by weight and preferably from 50% to 98% by weight relative to the total weight of the composition.

Mention may be made more particularly of monoalcohols such as ethanol and isopropanol, polyalcohols such as diethylene glycol and glycerol, glycol ethers, and alkyl ethers of glycol or of diethylene glycol.

The compositions according to the invention preferably have a final pH generally of between 3 and 10. This pH is more preferably between 4 and 8. The pH may be adjusted to the desired value in a conventional manner by adding a base (organic or mineral base) to the composition, for example aqueous ammonia or a primary, secondary or tertiary (poly)amine, for instance monoethanolamine, diethanolamine, triethanolamine, isopropanolamine or 1,3-propanediamine, or alternatively by adding an acid, preferably a carboxylic acid such as, for example, citric acid.

The compositions in accordance with the invention may contain, in addition to the combination defined above, viscosity regulators such as electrolytes, or thickeners (associative or nonassociative thickeners). Mention may be made in particular of sodium chloride, sodium xylenesulfonate, scleroglucans, xanthan gums, fatty acid alkanolamides, alkyl ether carboxylic acid alkanolamides optionally oxyethylenated with up to 5 mol of ethylene oxide, such as the product sold under the name “Aminol A15” by the company Chem Y, crosslinked polyacrylic acids and crosslinked acrylic acid/C₁₀-C₃₀ alkyl acrylate copolymers. These viscosity regulators are used in the compositions according to the invention in proportions that may be up to 10% by weight relative to the total weight of the composition.

The compositions in accordance with the invention may also preferably contain up to 5% of nacreous agents or opacifiers that are well known in the prior art, such as, for example, C16 higher fatty alcohols, fatty-chain acyl derivatives such as ethylene glycol or polyethylene glycol monostearate or distearate, and fatty-chain ethers such as, for example, distearyl ether or 1-(hexadecyloxy)-2-octadecanol.

The compositions in accordance with the invention may also optionally contain at least one additive chosen from foam synergists such as C₁₀-C₁₈ 1,2-alkanediols or fatty alkanolamides derived from monoethanolamine or diethanolamine, silicone-based or non-silicone-based sunscreens, anionic, nonionic, amphoteric or cationic polymers other than the polyalkyleneimines of the invention, proteins, protein hydrolysates, hydroxy acids, vitamins, provitamins such as panthenol, volatile or non-volatile, linear or cyclic, crosslinked or non-crosslinked, organomodified or non-organomodified silicones, synthetic oils such as poly-α-olefins, fluoro oils, fluoro waxes, fluoro gums, carboxylic acid esters, mineral, plant or animal oils, ceramides and pseudoceramides, and mixtures thereof.

Needless to say, a person skilled in the art will take care to select this or these optional additional compound(s) and/or the amounts thereof such that the advantageous properties intrinsically associated with the combination in accordance with the invention are not, or are not substantially, adversely affected by the envisaged addition(s).

These additives are optionally present in the composition according to the invention for example in proportions that may range from 0.00001% to 20% by weight relative to the total weight of the composition. The precise amount of each additive is readily determined by a person skilled in the art depending on its nature and its function.

The compositions may be in any form, including the form of fluid or thickened liquids, gels, creams, mousses, and water-in-oil (W/O) or oil-in-water (O/W) emulsions or multiple emulsions.

They may be used, for example, as shampoos, rinse-out care products, deep-down care masks, or lotions or creams for treating the scalp.

These compositions are mainly suitable for washing and caring for keratin materials, in particular the hair and the skin, and even more particularly the hair.

The compositions of the invention may more particularly be in the form of shampoos, rinse-out or leave-in conditioners, permanent-waving, relaxing, dyeing or bleaching compositions, or alternatively in the form of compositions to be applied before or after dyeing, bleaching, permanent-waving or relaxing the hair or even between the two steps of a permanent-waving or hair-relaxing operation. The compositions are preferably washing and foaming compositions for the skin and/or the hair.

In particular, the compositions according to the invention are foaming detergent compositions such as shampoos, shower gels and bubble baths. In this embodiment of the invention, the compositions comprise at least one detergent surfactant.

The detergent surfactant(s) may be chosen without preference, alone or as mixtures, from the anionic, amphoteric, nonionic, zwitterionic and cationic surfactants described above.

The minimum amount of surfactant is the amount that is just sufficient to give the final composition satisfactory foaming power and/or detergent power.

Thus, according to the invention, the detergent surfactant may represent for example from 3% to 30% by weight, preferably from 6% to 25% by weight and even more preferably from 8% to 20% by weight relative to the total weight of the final composition.

When the compositions in accordance with the invention are used as standard shampoos, they are simply applied to wet hair and the lather generated by massaging or rubbing with the hands is then removed, after an optional action time, by rinsing with water, the operation possibly being repeated one or more times.

A subject of the invention is also a process for washing and conditioning keratin materials, especially such as the hair, which consists in applying a composition as defined above and then in rinsing with water, after an optional action time.

The compositions according to the invention are preferably used as shampoos for washing and conditioning the hair, and they are applied in this case to damp hair in amounts that are efficient to wash the hair, this application being followed by rinsing with water.

The compositions in accordance with the invention may also be used as shower gels for washing and conditioning the hair and/or the skin, in which case they are applied to the damp skin and/or hair and are rinsed out after application.

The compositions of the invention may also be used in leave-in mode, and in particular in lotions, in gels, in mousses or in aerosols.

According to the invention, a premix of the particles and of the polyalkyleneimine is prepared and is introduced into the composition comprising the surfactants.

Concrete, but in no way limiting, examples illustrating the invention will now be given.

### EXAMPLE 1

The shampoo composition below was prepared: Triethanolamine lauryl sulphate as an

| | |
|---|---|
| aqueous solution containing 40% AM | 31.2 g |
| (C1/C9) alkyl polyglucoside [1,4] as an | 6.25 g |
| aqueous 40% solution | |
| Polyethyleneimine (Lupasol FG from BASF) | 0.015 g |
| Powdered calcium carbonate (Omyapur 35 sold | 3 g |
| by Omya) | |
| pH agent qs | pH = 7 |
| Water qs | 100 g |

The composition has a pleasant texture when applied to damp hair. It rinses out well. The wet hair is not laden and is easy to shape.

### EXAMPLE 2

The shampoo composition below was prepared: Sodium laurylether sulphate as an aqueous

| | |
|---|---|
| solution containing 30% AM | 17.8 g |
| Cocoylamidopropyl betaine as an aqueous | 8.3 g |
| solution containing 30% AM | |
| Polyethyleneimine (Lupasol FG from BASF) | 0.015 g |
| Powdered laponite (Laponite XLG from | 3 g |
| Laporte) | |
| pH agent qs | pH = 7 |
| Water qs | 100 g |

The composition has a pleasant texture when applied to damp hair. It rinses out well. The wet hair is not laden and is easy to shape.

### EXAMPLE 3

The lotion below was prepared:

| | |
|---|---|
| Polyethyleneimine (Lupasol FG from | 0.015 g |
| BASF) | |
| Powdered calcium carbonate (Omyapur 35 sold | 3 g |
| by Omya) | |
| pH agent qs | pH = 7 |
| Water qs | 100 g |

The frictional forces were measured on locks of natural dried hair using a sliding bench.

A mobile lock, attached to a sliding bench, is entrained in a horizontal rectilinear motion between two other fixed locks. The force to be exerted to make the lock slide is measured using an electronic gauge connected to the drive arm. The greater the sliding force, the greater the effects of the deposit of the particles. The styling effect is reinforced.

The results are collated in the table below:

| | Example 3 with | Comparative (PEI |
|---|---|---|
| | calcium carbonate | free) |
| Frictional forces | 30.8 g | 25.2 g |

The sliding force for the composition containing calcium carbonate and polyethyleneimine (PEI) according to the invention is markedly higher than that for the PEI-free composition.

### EXAMPLE 4

The lotion below was prepared:

| | |
|---|---|
| Polyethyleneimine (Lupasol FG from | 0.015 g |
| BASF) | |
| Powdered laponite (sodium lithium magnesium | 3 g |
| silicate) (Laponite XLG from Laporte) | |
| pH agent qs | pH = 7 |
| Water qs | 100 g |

The frictional forces were measured on locks of natural dried hair using a sliding bench.

A mobile lock, attached to a sliding bench, is entrained in a horizontal rectilinear motion between two other fixed locks. The force to be exerted to make the lock slide is measured using an electronic gauge connected to the drive arm. The greater the sliding force, the greater the effects of the deposit of the particles. The styling effect is reinforced.

The results are collated in the table below:

| | Example 4 with | Comparative (PEI |
|---|---|---|
| | Laponite | free) |
| Frictional forces | 25.7 g | 19.3 g |

The sliding force for the composition containing laponite and polyethyleneimine (PEI) according to the invention is markedly higher than that for the PEI-free composition.

The above written description of the invention provides a manner and process of making and using it such that any person skilled in this art is enabled to make and use the same, this enablement being provided in particular for the subject matter of the appended claims, which make up a part of the original description.

As used above, the phrases “chosen from,” “selected from the group consisting of,” and the like include mixtures of the specified materials.

All references, patents, applications, tests, standards, documents, publications, brochures, texts, articles, etc. mentioned herein are incorporated herein by reference. Where a numerical limit or range is stated, all values and subranges therewithin are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A composition comprising, in a cosmetically acceptable medium:
solid mineral particles comprising at least one element selected from the group consisting of columns IIa, IIIa and IVa of the Periodic Table of the Elements, and
at least one polyalkyleneimine,
the polyalkyleneimine/mineral particle weight ratio being 0.1-0.0001.

2. The composition according to claim 1, wherein the solid particles have a number-average primary size of 2 nm-2 microns.

3. The composition according to claim 1, wherein the particles are selected from the group consisting of particles comprising at least 10% by weight of calcium carbonate, particles comprising at least one silicate, particles comprising at least 90% aluminium oxide, silicas, magnesium oxide, barium sulphate, and mixtures thereof.

4. The composition according to claim 1, wherein the particles comprise at least 50% by weight of calcium carbonate.

5. The composition according to claim 1, wherein the particles are particles of substantially pure calcium carbonate.

6. The composition according to claim 1, wherein the solid particles are present in an amount of 0.01%-30% by weight.

7. The composition according to claim 1, comprising a polyalkyleneimine comprising the following repeating units: 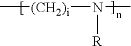
in which:
i represents an integer greater than or equal to 2;
n represents an integer ranging from 6 to 20 000;
R represents a hydrogen atom or a unit 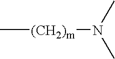
in which m represents an integer greater than or equal to 2.

8. The composition according to claim 1, comprising a poly(C2-C4)alkyleneimine.

9. The composition according to claim 1, comprising a polyethyleneimine.

10. The composition according to claim 1, wherein the said polyalkyleneimine(s) has (have) a weight-average molecular weight ranging of 300-100 000.

11. The composition according to claim 10, wherein the said polyalkyleneimine(s) has (have) a weight-average molecular weight of 350-50 000.

12. The composition according to claim 11, wherein the said polyalkyleneimine(s) has (have) a weight-average molecular weight of 400-10 000.

13. The composition according to claim 1, wherein the said polyalkyleneimine(s) is (are) present in an amount of 0.0005%-5% by weight relative to the total weight of the composition.

14. The composition according to claim 1, further comprising at least one additive selected from the group consisting of foam synergists, silicone-based or non-silicone-based sunscreens, surfactants, anionic, nonionic, amphoteric or cationic polymers other than polyalkyleneimines, proteins, protein hydrolysates, hydroxy acids, vitamins, provitamins, and volatile or non-volatile, linear or cyclic, crosslinked or non-crosslinked, organomodified or non-organomodified silicones.

15. The composition according to claim 2, wherein the solid particles have a number-average primary size of 10-250 nm.

16. The composition according to claim 1, wherein the particles comprise more than 90% by weight of calcium carbonate.

17. The composition according to claim 6, wherein the solid particles are present in an amount of 0.05%-10% by weight relative to the total weight of the composition.

18. The composition according to claim 7, wherein i=2;
n represents an integer of 8-2 500; and
R represents a hydrogen atom or a unit 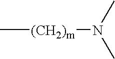
in which m=2.

19. The composition according to claim 1, wherein the said polyalkyleneimine(s) is (are) present in an amount of 0.005%-0.25% by weight relative to the total weight of the composition.

20. The composition according to claim 1, whrein said composition is a shampoo.

21. A method, comprising applying to human keratin the composition of claim 1.

22. The method of claim 21, comprising applying said composition to human hair.

23. The method of claim 22, wherein said application provides the hair with a greater sensation of thickness and better hold of the hairstyle.

24. A process for washing and conditioning the hair, comprising applying a washing and conditioning effective amount of a composition as defined in claim 1 to the hair, and then rinsing the hair with water after an optional action time.
